(19) United States
(12) Patent Application Publication
(10) Pub. No.: US 2003/0182966 A1
(43) Pub. Date: Oct. 2, 2003

(54) Device for homogenous heating glasses and/or glass ceramics

(76) Inventors: Ulrich Fotheringham, Wiesbaden (DE); Bernd Hoppe, Ingelheim (DE); Hauke Esemann, Worrstadt (DE); Michael Kluge, Offenbach (DE)

Correspondence Address: Charles N J Ruggiero, Ohlandt Greeley Ruggiero & Perle, 10th Floor, One Landmark Square, Stamford, CT, 06901-2682, US

(21) Appl. No.: 10/312,060

(22) PCT Filed: Jun. 15, 2001
(86) PCT No.: PCT/EP01/06804

(30) Foreign Application Priority Data
Jun. 21, 2000 (DE) DE100 29 522.3-45

(51) Int. Cl. C03B 32/00

(52) U.S. Cl. 65/33.2

(57) ABSTRACT

The invention concerns a device for the heating of glasses and/or glass ceramics, comprising one or more IR radiators. The invention is characterized in that the device comprises at least one filter element, which filters at least a portion of the long-wave IR radiation of the IR radiators, so that no long-wave IR radiation or only a small amount impinges on the one or more glass-ceramic and/or glass parts to be heated.

The invention concerns a device for the homogeneous heating of glass or glass ceramics as well as a method for heating with such a device.

In order to endow them with specific material properties, for example, making ceramics, semitransparent or transparent glass and/or glass ceramics are heated for the most part to temperatures which preferably lie above the lower cooling point (viscosity η=10^{14.5} dpas). In shaping processes, particularly hot post-processing, the semitransparent or transparent glass and/or glass ceramics are heated up to the processing point (viscosity η=10^{14.5} dpas) or above. Typical lower cooling points can lie between 282° C. and 790° C., depending on the type of glass, and typically, the processing point is up to 1705° C.

Glass ceramics and/or glasses are currently preferably heated by using high-power surface heaters, such as gas burners, for example.

Surface heaters are generally defined as those heaters in which at least 50% of the total heating power of the heat source is applied to the surface or layers near the surface of the object to be heated.

If a radiation source is black or gray and it has a color temperature of 1500 K, then the source emits 51% of the total radiation power in a wavelength region above 2.7 μm. If the color temperature amounts to less than 1500 K, as is the case in most electrical resistance heaters, then essentially more than 51% of the total radiation power is emitted above 2.7 μm.

Since most glasses have an absorption edge in this wavelength region, 50% or more of the radiation power is absorbed by the surface or in layers near the surface. Thus, one can speak of a surface heating.

One special type of surface heating is heating with a gas flame, wherein typically the flame temperatures lie at 1000° Celsius. Heating by means of a gas burner proceeds for the most part by transfer of the heat energy of the hot gas to the surface of the glass ceramics or the glass. A temperature gradient can result from this, which, e.g., can disadvantageously influence the shaping of the glass, for example, due to viscosity gradients. This particularly applies to glass thicknesses≧5 mm.

In general, with surface heaters, the surface or layers near the surface are heated at places of the glass or glass ceramics which lay facing the heat source. The remaining volume of the glass or glass ceramics must correspondingly be heated by heat conduction inside the glass or glass ceramics.

Since glass or glass ceramics usually have a very small heat conductivity in the range of 1 W/(mK), they ceramics must be heated continuously more slowly as their thickness increases, in order to minimize stresses in the glass or glass ceramics.

In order to achieve a rapid thorough heating of the glass by means of heat conduction, a high power input is necessary in the case of gas burners. Such a heating is limited to small surfaces, since it is impossible to introduce the required power density over the entire surface by means of gas burners.

If a homogeneous heating of the glass or glass ceramics is not achieved, or is achieved only insufficiently, then this undeniably has as a consequence irregularities in the process and/or product quality. For example, in the case of the ceramizing process of glass ceramics, each irregularity in conducting the process leads to a bending or cracking of the glass ceramics.

Another possibility for heating and/or shaping is heating glass and/or glass ceramics or rather a glass and/or glass-ceramic blank with the application of IR radiation, preferably short-wave IR radiation.

A method and a device comprising an IR radiator for the rapid heating of materials which have a high absorption above 2500 nm, have become known from DE 4,202,944 C2. In order to be able to rapidly input heat emitted into the material by the IR radiators, DE 4,202,944 C2 proposes the use of a radiation converter, from which secondary radiation is emitted in a wavelength region which is shifted to the long-wave region when compared with the primary radiation.

US-A-3,620,706 describes a homogeneous heating of the deeper parts of transparent glass with the use of short-wave IR radiators. The method according to US-A-3,620,706 is based on the fact that the absorption length of the radiation used is a great deal longer than the dimensions of the glass objects to be heated, so that the glass allows most of the impinging radiation to pass, and the absorbed energy per unit of volume is nearly equal at any point of the glass body. It is a disadvantage in this method, however, that a homogeneous irradiation over the surface of the glass object is not assured, so that the intensity distribution of the IR radiation source is “mapped” on the glass to be heated. Also, only a small part of the electrical energy introduced is utilized for the heating of the glass.

The heating of the glass or glass ceramics is conducted by means of short-wave IR radiators, in part by radiation in a wavelength region in which the glass or glass ceramics are extensively transparent, which is in the range of<2.7 μm for most glasses. When radiators with a color temperature of 3000 K are used, for example, 86% of the emitted radiation is allotted to this region. This short-wave fraction of the radiation is absorbed only slightly by the glass, so that the energy contribution is made extensively homogeneously throughout the depth, as long as the dimensions of the glass part to be heated are clearly smaller than the absorption length of the radiation used in the glass. In order to prevent a large portion of the radiation utilized from again leaving the glass unutilized after a single passage, heating can be conducted inside an IR radiation cavity with good reflecting or backscattering limiting surfaces, whereby the indicated disadvantage of the method described in US-A-3,620,706 is overcome.

A small fraction of the radiation emitted by the IR radiators, which are optionally found inside a radiation cavity-at a color temperature of 3000 K, this amounts to 14%—however, is allotted to the wavelength region>2.7 μm, in which most glasses absorb intensely, so that here an input of energy into the surface or the layers near the surface of the glass occurs. This limits the temperature homogeneity that can be obtained by heating, so that the application of this heating method is limited to processes which have only small requirements relative to avoiding temperature gradients in the glass, for example, processes which permit a temperature gradient of 30 K/cm or more.

If heating by means of short-wave JR radiators is also to be used for processes in which the product quality is sensitively dependent on the temperature homogeneity, then the object is to produce a device or a method, with which a heating of the glass that is effective in the deep parts is made possible by means of short-wave TR radiation, without the unavoidable fraction of long-wave radiation contained in the spectrum of the radiator (i.e., >2.7 μm) leading to inadmissible temperature gradients within the glass and/or the glass ceramics.

According to the invention, this object is solved in that the device for heating contains a filter, which essentially lets pass only the short-wave portion of the radiation, while the long-wave portion, in contrast, is at least partially filtered, for example, absorbed or reflected so that no long-wave radiation or only a small amount impinges on the glass or the glass ceramics to be heated.

Advantageously, such a filter can consist of a flat disk or a casing around the IR radiator. An OH-rich glass is preferably used as the material for the filter, and this glass preferably absorbs to a lesser extent in the short-wave region than the glass or the glass ceramics to be heated. It is assured in this way that the absorption edge of the filter lies precisely at 2.7 μm and thus only a minimum of radiation that is effective in the deep parts (<2.7 μm) will be absorbed, but a maximum of undesired radiation that acts on the surface (>2.7 μm) will be absorbed.

In order to avoid an inadmissible heating of the filter, the latter can be cooled, for example, air-cooled. It is particularly advantageous if the filter represents a casing of the IR radiator. Then an air cooling of the IR radiator can be used simultaneously, for example, for the cooling of the casing and thus of the filter.

It is particularly advantageous if synthetic, i.e., OH-rich quartz glass is used as the material for the filter. The latter combines the properties of a minimal absorption in the shortwave region and a good absorption of long-wave radiation with the particular advantage of high thermal roadability and resistance to temperature change.

The filter can be optionally designed of quartz or another glass, so that the radiation that passes through is diffusely scattered in such a way that the filter also assumes the function of a scattering disk. In this way, a “mapping” of the radiation source on the body of the glass or glass ceramics to be heated can be avoided, which is accompanied by an improvement of the lateral temperature homogeneity.

It is particularly advantageous to arrange the IR radiators in an IR radiation cavity.

IR radiation cavities are shown, for example, in US-A-4,789,771 and EP-A-0 133,847, the disclosure content of which is fully incorporated in the present application. Preferably, the component of infrared radiation, which is reflected and/or scattered to the bottom and/or the top, amounts to more than 50% of the radiation impinging on these surfaces.

More preferably, the fraction of the infrared radiation which is reflected and/or scattered from the wall surfaces to the bottom and/or the top amounts to more than 90%, particularly more than 98%.

A particular advantage of the use of an IR radiation cavity is that with the use of very strongly reflecting and/or backscattering materials for the walls, bottom and/or top, a cavity of high quality Q is involved, which is associated only with small losses and thus assures a high energy utilization.

When diffusely back-scattering materials for walls, top and/or bottom are used, a particularly uniform radiation through all volume elements of the cavity is achieved at all angles. Thus, possible shading effects are avoided in the case of complexly shaped glass ceramic parts and/or glass parts.

For example, polished Quarzal plates with a thickness of 30 mm, for example, can be used as backscattering, i.e., spectral-reflecting wall material.

Other materials backscattering IR radiation are also possible as materials for walls, top and/or bottom or coating of the IR radiation cavity, for example, one or more of the following materials:

Al₂O₃; BaF₂; BaTiO₃; CaF₂; CaTiO₃;

MgO·3.5 Al₂O₃; MgO, SrF₂; SiO₂;

SrTiO₃; TiO₂; spinel; cordierite;

cordierite-sintering glass ceramics

In a preferred form of embodiment of the invention, the IR radiators have a color temperature greater than 1500 K, more preferably greater than 2000 K, even more preferably greater than 2400 K, particularly greater than 2700 K, and even more preferably, greater than 3000 K.

In order to avoid an overheating of the IR radiators, the latter are advantageously cooled, particularly cooled by air or water.

For the targeted heating of the glass or the glass ceramics, for example, by means of directed radiators, it is provided that the IR radiators can be turned off individually, and in particular, their electrical power can be controlled.

In addition to the device, the invention also makes available a method for the heating of glass ceramics and/or glass parts, in which the IR radiation is filtered, so that no long-wave IR radiation or only a negligibly small amount impinges on the glass-ceramic or glass part to be heated.

In one configuration of the invention, it is provided that the heating of the glass ceramics and/or the glass is partly carried out directly with the IR radiation of the IR radiators, and partly indirectly by the IR radiation reflected or backscattered by the walls, the top and/or the bottom of the IR radiation cavity.

It is particularly advantageous, if the fraction of indirect, i.e., backscattered or reflected radiation, which acts on the glass or glass-ceramic blank to be heated, amounts to more than 50%, preferably more than 60%, preferably more than 70%, even more preferably more than 80%, even more preferably more than 90%, and particularly more than 98% of the total radiation power.

The invention will be described below, for example, on the basis of the figures as well as examples of embodiment.

Here:

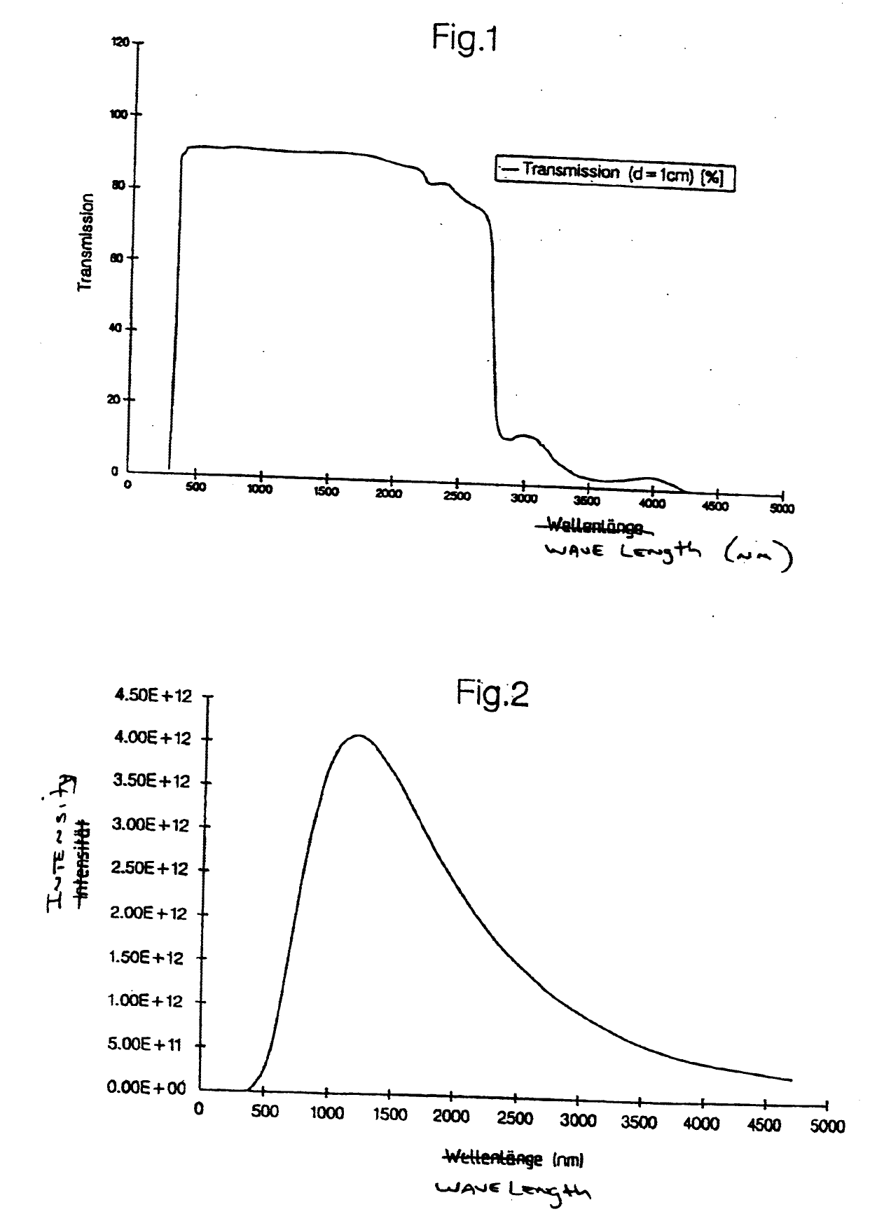

FIG. 1 shows the transmission curve of a glass specimen with a thickness of 1 cm, for example, plotted against wavelength.

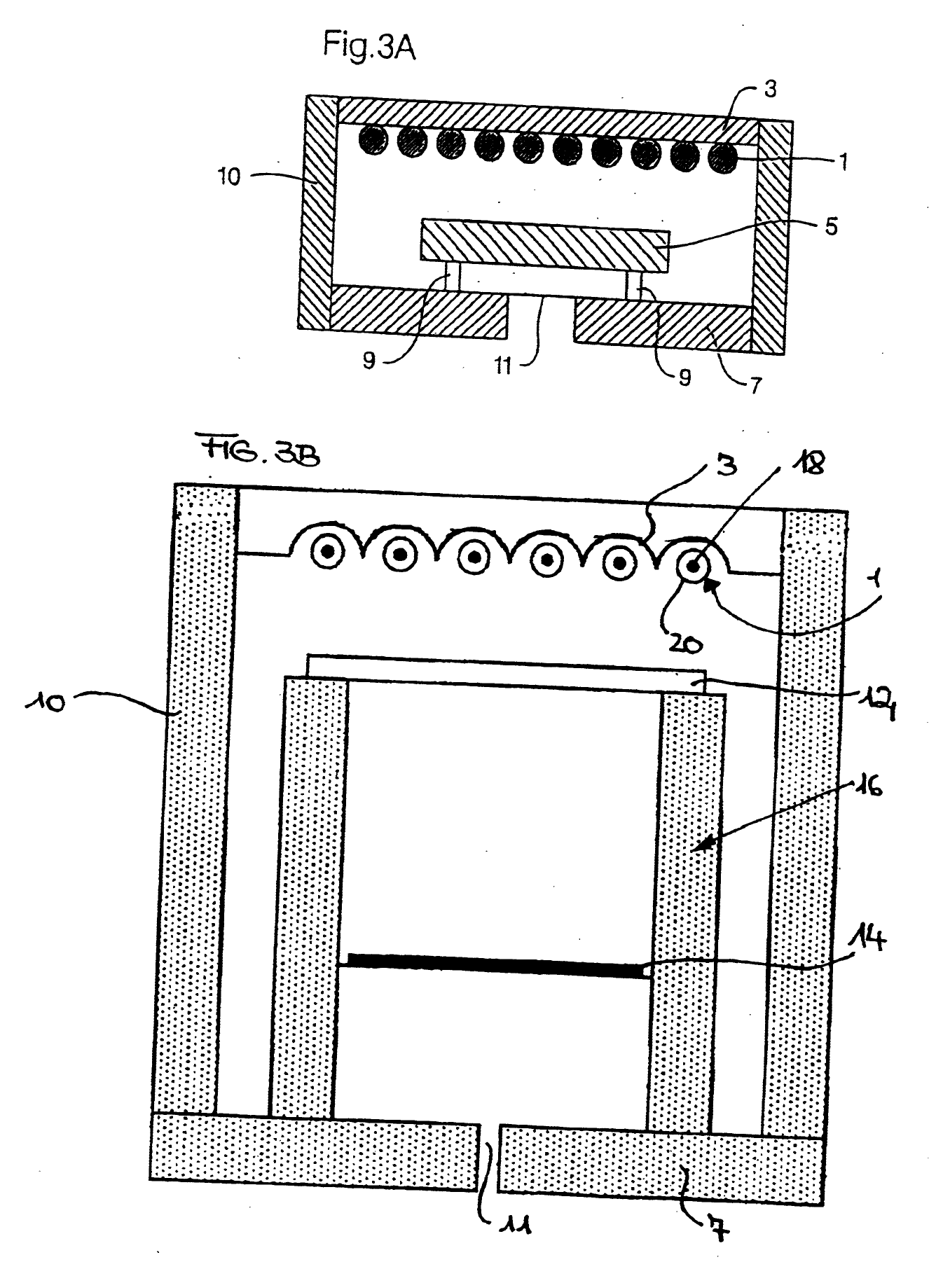

FIG. 2 shows the Planck curve of a possible IR radiator with a temperature of 2400 K.

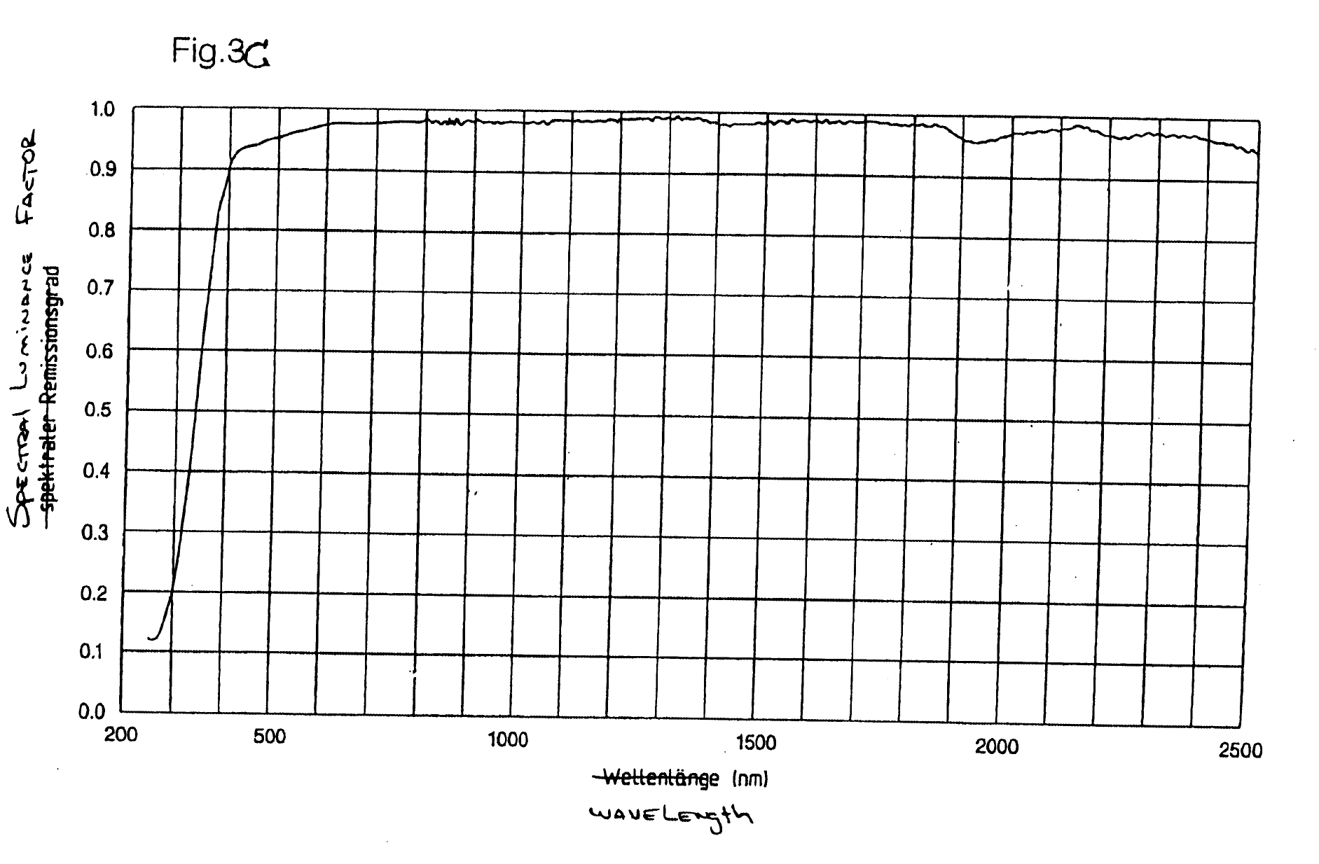

FIG. 3A shows the construction principle of a heating device with radiation cavity.

FIG. 3B shows the construction of a heating device with a filter according to the invention.

FIG. 3C shows the spectral-reflection curve as a function of the wavelength of AI₂O₃ Sintox AL of the Morgan Matroc company, Troisdorf, with a luminance factor>95%, over a wide spectral region>98%, in the IR wavelength region.

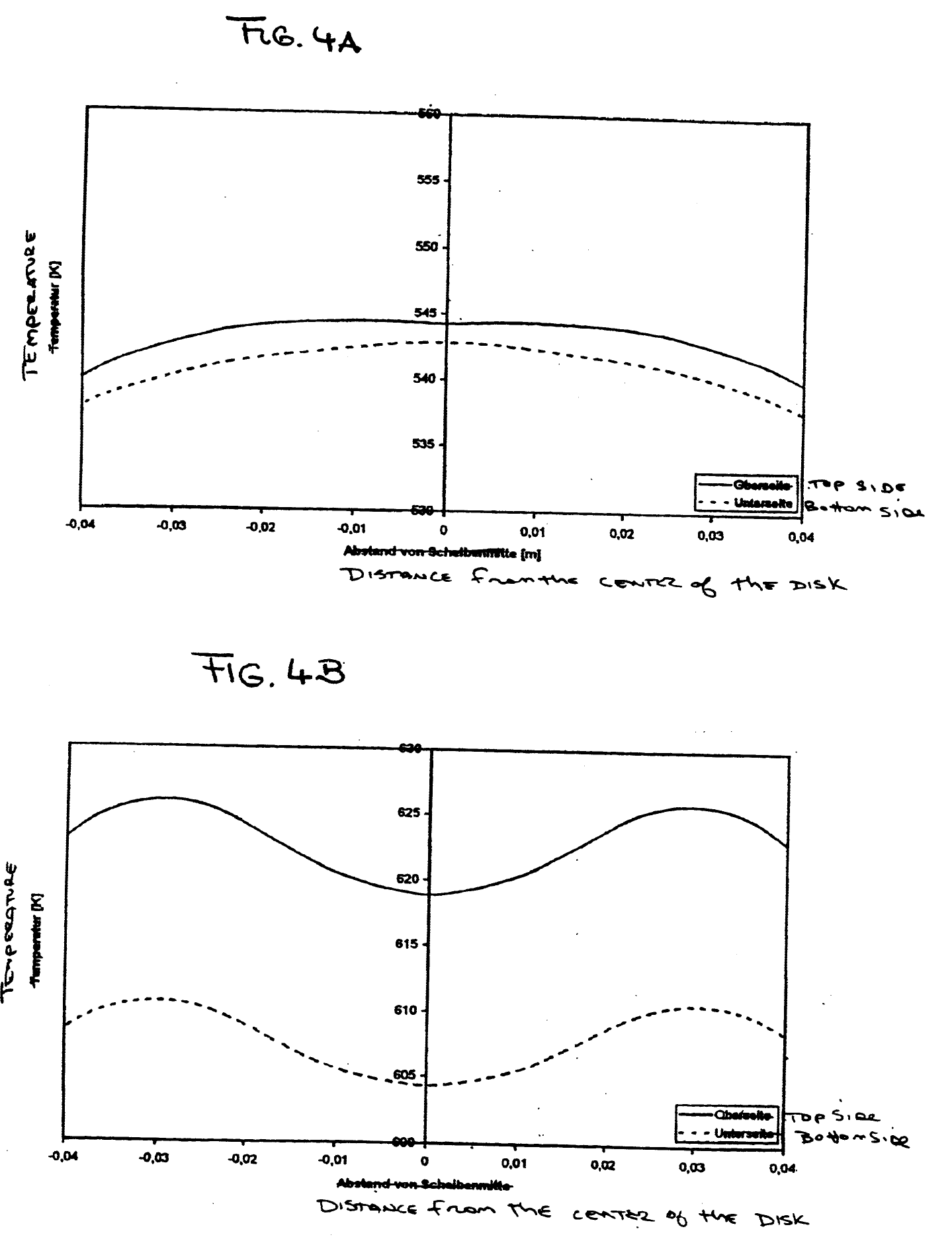

FIG. 4A shows the temperature distribution on the top and bottom sides of a heated glass disk after heating with a device according to the invention with a high-pass filter.

FIG. 4B shows the temperature distribution on the top and bottom sides of a heated glass disk after heating with a device without a high-pass filter.

FIG. 1 shows the transmission curve as a function of wavelength of a glass as an example. The glass has a thickness of 10 mm. The typical absorption edge at 2.7 μm can be clearly recognized, beyond which glass or glass ceramics are opaque, so that the total incident radiation is absorbed at the surface or in the layers near the surface.

FIG. 2 shows the intensity distribution of an IR radiation source, as can be used for the heating of a glass or glass-ceramic part according to the invention. The IR radiators which are used can be linear halogen IR quartz tube heaters with a rated power of 2000 W with a voltage of 230 V, which possess, for example, a color temperature of 2400 K. These IR heaters or radiators have their radiation maximum at a wavelength of 1210 nm corresponding to Wien's displacement law.

The intensity function of the IR-radiation source is produced accordingly from the Planck function of a black body with a temperature of 2400 K. Thus, it follows that a noteworthy intensity, i.e., greater than 5% of the radiation maximum in the wavelength region of 500 to 5000 nm is reflected and overall 75% of the total radiation power is allotted to the region above 1210 nm.

In a first embodiment of the invention, only the material to be annealed is heated, while the surroundings remain cold. The radiation that bypasses the material to be annealed is deflected by reflectors or diffuse scattering means or diffuse backscattering means onto the material to be annealed. In the case of high power densities and preferably metal reflectors, the reflectors are water-cooled, since if they were not, the reflector material would oxidize or tarnish. This danger is particularly present for aluminum, since this material is highly desirable for use in radiators of particularly high radiation power, due to its good reflection properties in the short-wave IR region. As an alternative to metal reflectors, diffusely backscattering ceramic diffusers or partially reflecting and partially backscattering glazed ceramic reflectors, for example, Al₂O₃, can be used.

A construction in which only the material to be annealed is heated can only be applied if a slow cooling is not needed subsequent to heating, which can be done with an acceptable temperature homogeneity and without an insulating space only with constant post-heating and only with very great expenditure.

The advantage of such a construction is the easy access, for example, for a gripping means, which is of interest particularly in hot shaping.

Alternatively, the heating device and the material to be annealed or the glass or the glass ceramics to be heated can be found in an IR radiation cavity equipped with IR radiators. It is presumed that the quartz glass radiators themselves are sufficiently termperature-resistant or are appropriately cooled. IR radiators consisting of a heating coil and typically a quartz glass tube can include for this purpose an additional casing through which flows a cooling agent, for example the casing can be another quartz glass tube. It is preferred that the quartz glass tubes are designed considerably longer than the heating coil and are guided out of the hot region, so that the connections are made in the cold region in order not to overheat the electrical connections. The quartz glass tubes can be produced with or without a coating.

FIG. 3A shows a first embodiment of a heating device for a shaping method with an IR radiation cavity.

The heating device shown in FIG. 3A comprises a plurality of IR radiators 1, which are arranged underneath a reflector 3 of strongly reflecting or strongly backscattering material. Reflector 3 serves for the purpose of deflecting onto the glass the power that was emitted by the IR radiator in other directions. The IR radiation emitted by the IR radiators partially penetrates the semitransparent glass 5 in this wavelength region and strikes a support plate 7 made of strongly reflecting or strongly scattering material. Quarzal, which reflects approximately 90% of the incident radiation even in the infrared, is particularly suitable for this purpose. Alternatively, Al₂O₃, which has a degree of reflection or a luminance factor of approximately 98%, could also be used for this purpose. The remission curve of an AI₂O₃ material as a function of wavelength is shown in FIG. 3C. Glass 5 is attached on support plate 7 by means of, for example, Quarzal or Al₂O₃ strips 9. The temperature of the bottom side can be measured by means of a pyrometer introduced through a hole 11 in the support plate.

Walls 10 can form an IR radiation cavity of high quality together with reflector 3 as the top and support plate 7 as the bottom with an appropriate configuration using reflecting or diffusely backscattering material, for example Quarzal or AI₂O₃.

FIG. 3B shows a device for heating glass and/or glass ceramics with a high-pass filter according to the invention.

Walls 10 and the bottom or the support plate 7 of the device shown in FIG. 3B are made of Quarzal.

The Quarzal oven 16 shown in FIG. 3B is essentially cylindrical with an inner diameter Dᵢ=120 mm, an outer diameter Dₒ=170 mm and a height H=160 mm. The Quarzal oven comprises a bottom plate and is covered with a plate 12 made of OH-rich synthetic quartz glass with a thickness of d=6.3 mm. This plate 12 serves as a filter for long-wave IR radiation emitted by the IR radiators 1. By introducing filter plate 12, which acts as a high-pass filter, the radiation emitted by the IR radiators 1 is filtered in such a way that either no long-wave IR radiation or only a negligibly small amount impinges on the glass 14 to be heated. The glass 14 is a 4-mm thick disk of a lithium aluminosilicate glass, which is attached in the edge region by small magnesium-oxide rods, and is disposed inside a Quarzal oven at a height of 60 mm above the bottom. Heating is conducted by an IR surface heating module which is found 200 mm above the bottom and consists of six IR radiators 1 arranged in a gold-plated reflector 3, comprising a heating coil 18 and a quartz glass tube 20, these radiators have a color temperature of 3000 K in the present example of embodiment, with a power density of a maximum of 600 kW/m². In order to avoid energy losses, the described construction is found inside an additional Quarzal radiation cavity, formed by walls 10 and bottom 7. A Eurotherm-PC3000 system, which carries out the temperature measurement by means of a 5μpyrometer introduced through a hole 11 in bottom plate 7, serves as the control.

As an alternative to a configuration with a filter plate 12, it would also be possible for the heating units to comprise IR radiators with a casing, whereby the casing consists of a material which acts as a high-pass filter. For example, the quartz glass tubes of the embodiment according to FIG. 3A, which surround the heating coil itself, could consist of an OH-rich, synthetic quartz glass or could be ensheathed by an additional quartz glass tube of this type. The advantage of such a configuration can be seen, for example, in the fact that the same cooling medium, which is used for cooling of the IR radiators, can be used for cooling the filter medium, which is heated by the absorption of long-wave radiation.

The heating process or the heat treatment can be conducted as described below:

The glass or glass ceramics are first heated in an IR radiation cavity retrofitted with Quarzal according to FIG. 3A, the top of which is formed by an aluminum reflector with IR radiators found thereunder, or a device according to FIG. 3B. The specimens are suitably placed inside.

The glass or the glass ceramics are directly irradiated in the IR radiation cavity by several halogen IR radiators.

The respective glass or glass ceramics are heated by means of controlling the IR radiators by means of a thyristor control based on absorption, reflection and scattering processes, as will be described in detail below:

Since the absorption length of the short-wave IR radiation used in the glass is much longer than the dimensions of the objects to be heated, most of the incident radiation is allowed to pass through the specimen. On the other hand, since the absorbed energy per unit of volume is nearly equal at any point of the glass, a homogeneous heating is achieved through the entire volume. The IR radiators and the glass ceramics to be heated or the glass to be heated are found in a radiation cavity, whose walls, bottom and/or top are comprised of a material with a surface of high reflectivity, whereby at least a part of the walls, bottom and/or top surfaces predominantly diffusely backscatter the impinging radiation. In this way, most of the radiation that is first allowed to pass by the glass or glass ceramics again reaches the object that is to be heated after reflection or scattering at the wall, bottom and/or top, and is again partially absorbed. The path of the radiation that also passes through the glass or the glass ceramics in the second passage is analogous in continuing passes. Not only is a homogeneous heating in the deep parts achieved by this method, but also the energy that is introduced is utilized in a clearly better way than in the case when only a single passage through the glass or glass ceramics is utilized.

A small fraction of the radiation emitted by the radiators—at a color temperature of 3000 K, this amounts to 14%—however, is allotted to the wavelength region>2.7 μm, in which most glasses absorb intensely, so that this energy is introduced into the surface or the layers near the surface of the glass occurs. This limits the temperature homogeneity that can be achieved in heating.

Since the heating of transparent or semitransparent glass and/or glass ceramics by means of short-wave IR radiators is produced for the most part by radiation in a wavelength region in which the glass is extensively transparent, which for most glasses is in the range of less than 2.7 μm, it is provided according to the invention to filter out long-wave IR radiation by means of a high-pass filter. When radiators with a color temperature of 3000 K are used, for example, 86% of the emitted radiation is allotted to radiation with a wavelength<2.7 μm.

If the heating by means of short-wave IR radiators is also to be used for processes in which the product quality depends in a sensitive manner on the temperature homogeneity, then a heating of the glass by short-wave IR radiation that is effective in the deep parts must be attained without leading to an inadmissible temperature gradient inside the glass due to the unavoidable long-wave (i.e., >2.7 μm) fraction that is contained in the spectrum of the radiator. Such a temperature gradient can be avoided if, for example, a filter 12, as in the device according to FIG. 3b, is arranged between the IR radiators 1 and the glass piece to be heated, and this filter only allows the short-wave (i.e., <2.7 μm) fraction of the radiation to pass, while it absorbs or reflects the long-wave portion, so that no long-wave radiation or only a negligibly small amount impinges on the glass piece to be heated.

FIG. 4A shows the temperature distribution on the top side and on the bottom side of a lithium aluminosilicate (LAS) glass after 20 s of heating, starting at room temperature. It can be seen that the temperature difference between the top side and the bottom side of the LAS glass disk on average amounts to only approximately 2 K due to the use of the OH-rich quartz glass as a high-pass filter. The construction of the device for heating corresponds to that shown in FIG. 3B.

FIG. 4B shows for comparison the temperature distribution, which results under the same experimental conditions in a device according to FIG. 3B without the use of a filter disk. The maximum difference between the temperatures on the top side and bottom side amounts to 15 K in this case.

The invention provides for the first time a device and a method for heating, either a supportive or exclusive heating, of glasses or glass ceramics, which makes possible a homogeneous heating without the formation of a temperature gradient, has a high energy utilization and avoids a “mapping” of the radiation source on the object to be heated. The device can be utilized in many areas of glass processing. The following uses are listed only by way of example and are not conclusive:

—heating with homogeneous temperature of a glass ceramic blank in making ceramics

—rapid re-heating of glass blanks for a subsequent hot shaping

—homogeneous heating of fiber bundles to the drawing temperature

—supportive or exclusive heating for shaping, particularly for drawing, for rolling, for casting, for spinning, for pressing, for blowing in the blow-and-blow method, for blowing in the blow-and-press method, for blowing in the ribbon method, for plate-glass production as well as for float glass

—supportive or exclusive heating in the case of cooling, for fusion, for thermal strengthening, for stabilizing or fine cooling, to adjust a desired “fictitious” temperature, a desired refractive index, a desired compaction in the case of subsequent temperature treatment, for aging of thermometer glasses, for segregating mixtures, for staining of tarnished glasses, for controlled crystallizing, for diffusion treatment, particularly chemical strengthening, for transformations, particularly sagging, bending, drawing, blowing, for separating, particularly melting off, breaking, upsetting, rupturing, for cutting, for joining and for coating.

1. A device for the heating of glass and/or glass ceramics comprising
1.1 one or more IR radiators,
is hereby characterized in that
1.2 the device comprises at least one filter element, which filters at least one portion of the long-wave IR radiation of the IR radiators, so that no long-wave IR radiation or only a small amount impinges on the one or more glass-ceramic and/or glass parts to be heated.

2. The device according to claim 1, further characterized in that the device comprises an IR radiation cavity with IR radiation-reflecting or backscattering walls and/or top and/or bottom.

3. The device according to claim 1 or 2, further characterized in that the filter filters at least 50%, preferably 80%, more preferably 90%, even more preferably 95%, most preferably 98% of the IR radiation with a wavelength>2.7 μm, which is reflected by the one or more IR radiators.

4. The device according to one of claims 1 to 3, further characterized in that the filter absorbs long-wave IR radiation.

5. The device according to one of claims 1 to 3, further characterized in that the filter reflects long-wave IR radiation.

6. The device according to one of claims 1 to 5, further characterized in that the filter is a flat disk, which is disposed between the IR radiators and the the glass-ceramic and/or the glass part to be heated.

7. The device according to one of claims 1 to 5, further characterized in that the heating coils of the IR radiators are encased by at least one casing, whereby at least one of the casings represents the filter for filtering at least one part portion the long-wave radiation.

8. The device according to one of claims 1 to 7, further characterized in that the filter comprises an OH-rich glass, which, in the short-wave region, preferably absorbs to a lesser extent than the glass to be heated.

9. The device according to one of claims 1 to 8, further characterized in that the filter comprises a synthetic OH-rich quartz glass.

10. The device according to one of claims 1 to 9, further characterized in that the filter is designed so that the radiation that is allowed to pass is diffusely scattered.

11. The device according to one of claims 1 to 10, further characterized in that the filter is cooled.

12. The device according to one of claims 2 to 11, further characterized in that the reflectivity or the backscattering capacity of the walls and/or top and/or bottom amounts to more than 50% of the impinging radiation.

13. The device according to one of claims 2 to 12, further characterized in that the reflectivity or the backscattering capacity of the walls and/or top and/or bottom amounts to more than 90% or 95%, particularly more than 98% of the incident radiation.

14. The device according to one of claims 2 to 13, further characterized in that the material of the wall and/or top and/or the bottom is diffusely backscattering.

15. The device according to one of claims 2 to 14, further characterized in that the reflecting or backscattering walls and/or top and/or bottom comprise one or more of the following materials:
AI₂O₃; BaF₂; BaTiO₃; CaF₂; CaTiO₃;
MgO·3.5 Al₂O₃; MgO, SrF₂; SiO₂;
SrTiO₃; TiO₂; spinel; cordierite;
cordierite-sintering glass ceramics

16. The device according to one of claims 1 to 15, further characterized in that the IR radiators have a color temperature greater than 1500 K, more preferably greater than 2000 K, even more preferably greater than 2400 K, particularly greater than 2700 K, and most preferably greater than 3000 K.

17. The device according to one of claims 1 to 16, further characterized in that the IR radiators are cooled, particularly air or water-cooled.

18. The device according to one of claims 1 to 17, further characterized in that the IR radiators can be controlled individually and can be regulated with respect to their electrical power.

19. A method for heating with a device according to one of claims 1 to 18, is hereby characterized in that heating is conducted with the use of IR radiation, wherein the IR radiation is filtered by means of a filter for long-wave IR radiation, so that no long-wave IR radiation or only a small amount impinges on the glass-ceramic and/or glass part to be heated.

20. Use of a device according to one of claims 1 to 18 for the heating with homogeneous temperature of a glass-ceramic blank for producing ceramics.

21. Use of a device according to one of claims 1 to 18 for the rapid re-heating of glass blanks for a subsequent hot shaping.

22. Use of a device according to one of claims 1 to 18 for the homogeneous heating of fiber bundles to the drawing temperature.

23. Use of a device according to one of claims 1 to 18 for the supportive or exclusive heating for shaping, particularly for drawing, for rolling, for casting, for spinning, for pressing, for blowing in the blow-and-blow method, for blowing in the blow-and-press method, for blowing in the ribbon method, for plate-glass production as well as for float glass.

24. Use of a device according to one of claims 1 to 18 for the supportive or exclusive heating in the case of cooling, for fusion, for thermal strengthening, for stabilizing or fine cooling, to adjust a desired “fictitious” temperature, a desired refractive index, a desired compaction in the case of subsequent temperature treatment, for aging of thermometer glasses, for segregating mixtures, for staining of tarnished glasses, for controlled crystallizing, for diffusion treatment, particularly chemical strengthening, for transformations, particularly sagging, bending, drawing, blowing, for separating, particularly melting off, breaking, upsetting, rupturing, for cutting, for joining and for coating.
